(19) United States
(12) Patent Application Publication
(10) Pub. No.: US 2025/0388224 A1
(43) Pub. Date: Dec. 25, 2025

(54) SYSTEMS AND METHODS FOR ONLINE SENSOR CALIBRATION USING HAPTIC FEEDBACK

(71) Applicant: Torc Robotics, Inc., Blacksburg, VA (US)

(72) Inventors: Sebastian Beckmann, Stuttgart (DE); Stefan Oexl, Stuttgart (DE); Roman Keller, Denkendorf (DE); Tao Wang, Duesseldorf (DE)

(21) Appl. No.: 18/750,584

(22) Filed: Jun. 21, 2024

(51) Int. Cl. B60W 50/06; G01P 21/00

(52) U.S. Cl. CPC B60W 50/06; G01P 21/00

(57) ABSTRACT

A system for online sensor calibration of an autonomous vehicle is provided. The system includes a processor in communication with a memory device and a haptic sensor of the autonomous vehicle. The processor is programmed to detect, based on a haptic response received from the haptic sensor, a road feature over which the autonomous vehicle travels, and identify a location of the road feature as a ground-truth location of the autonomous vehicle at a time at which the autonomous vehicle traveled over the road feature. The processor is also programmed to calibrate at least one other sensor of the autonomous vehicle using the ground-truth location of the autonomous vehicle.

### TECHNICAL FIELD

The field of the disclosure relates generally to vehicle sensor systems and, more specifically, to systems for identifying and recalibrating misaligned sensors of a vehicle while the vehicle is online.

### BACKGROUND OF THE INVENTION

The integration of data from various sensor technologies, known as multi-source and multi-modal sensor fusion, is used in automated driving systems, such as those used in autonomous vehicles. This integration plays an essential role in overcoming limitations associated with relying on a single sensor source, particularly for key functions within an automated driving system, such as motion estimation, localization, or environment recognition.

Vehicle assembly techniques generally allow for certain tolerances that may lead to errors in orientations of vehicle sensors. Additionally, during operation, an orientation of sensors may be altered due to wear, vibrations, weather influences, or physical damage. These orientation errors deteriorate the performance of autonomous driving systems that utilize data generated by these sensors. In some cases, this may lead to safety hazards during autonomous driving such as inaccurate object detection and tracking, motion estimation, or localization. A system capable of identifying and correcting such orientation errors is therefore desirable.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, the disclosed system for sensor calibration includes comprising a processor in communication with a memory device and at least one haptic sensor of an autonomous vehicle. The processor is programmed to detect, based on a haptic response received from the haptic sensor, a road feature over which the autonomous vehicle travels, and identify a location of the road feature as a ground-truth location of the autonomous vehicle at a time at which the autonomous vehicle traveled over the road feature. The processor is also programmed to calibrate at least one other sensor of the autonomous vehicle using the ground-truth location of the autonomous vehicle.

In another aspect, the disclosed method for online sensor calibration of an autonomous vehicle, the autonomous vehicle including at least one haptic sensor, includes detecting, based on a haptic response received from the haptic sensor, a road feature over which the autonomous vehicle travels. The method also includes identifying a location of the road feature as a ground-truth location of the autonomous vehicle at a time at which the autonomous vehicle traveled over the road feature, and calibrating at least one other sensor of the autonomous vehicle using the ground-truth location of the autonomous vehicle.

In yet another aspect, the disclosed autonomous vehicle includes an autonomy computing system including at least one haptic sensor. The autonomy computing system is configured to detect, based on a haptic response received from the haptic sensor, a road feature over which the autonomous vehicle travels, and identify a location of the road feature as a ground-truth location of the autonomous vehicle at a time at which the autonomous vehicle traveled over the road feature. The autonomy computing system is also configured to calibrate at least one other sensor of the autonomous vehicle using the ground-truth location of the autonomous vehicle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3 depicts a first embodiment of capturing haptic feedback data for online sensor calibration;

FIG. 4 depicts a second embodiment of capturing haptic feedback data for online sensor calibration;

FIG. 5 depicts a third embodiment of capturing haptic feedback data for online sensor calibration;

FIG. 6 depicts a third embodiment of capturing haptic feedback data for online sensor calibration;

FIG. 7 is a flow diagram of an example method of online sensor calibration using haptic feedback; and

FIG. 8 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

In automated vehicle technologies, sensor calibration and subsequent recalibration is a necessary function. Specifically, once a sensor is detected to be miscalibrated, such a sensor is recalibrated during operation of the corresponding automated vehicle. In at least some known systems, the recalibration is performed relative to other sensors operating on the automate vehicle. It is contemplated that an error in calibration or recalibration (collectively “calibration,” herein) may compound across sensors, because there is no “ground truth” calibration.

The present disclosure is directed to enhancing current sensor calibration systems by providing a source of ground-truth data. In particular, haptic sensors detect features of a surface on which the vehicle is travelling. With high-resolution and detailed mapping data, the haptic feedback captured by the haptic sensors can provide a real-time and precise definition of at least one dimension of the online vehicle, which can then be incorporated into the calibration of other sensors. Additionally, the haptic feedback may be used to calculate a definitive localization of the vehicle.

The embodiments described herein include a system for sensor calibration, which includes a processor in communication with a memory device and at least one haptic sensor of an autonomous vehicle, which may include a microphone or accelerometer. The system is configured to detect, based on haptic feedback data received from the haptic sensor, a precise location and moment in time in which the autonomous vehicle encounters a known road feature while the autonomous vehicle is traveling, also referred to as being online. This haptic feedback data is processed and incorporated into the calibration of at least one other sensor of the autonomous vehicle. Moreover, in some embodiments, the haptic feedback data is incorporated into a localization function for the autonomous vehicle.

As described further herein, an autonomy system of the autonomous vehicle relies on very detailed map information related to a route over which the autonomous vehicle is directed to travel. In the example embodiments, these maps known road features. These known road features include features that induce a haptic response from the autonomous vehicle, such as outermost road/lane markings, expansion joints of roads or bridges, and other static and known “bumps in the road.” The maps also include haptic measurements of the road features, which were previously captured by other vehicles that have traveled over the road features. The autonomy system incorporates the haptic measurements and the corresponding localization data into the maps.

Accordingly, when an autonomous vehicle operated using those maps drives over the known road feature, as detected by the haptic sensor(s), the precise location of the vehicle – relative to at least one dimension of the vehicle – is known. When a discrepancy is detected between this precise location and other sensor data, the sensor(s) corresponding to the error may calibrated using the precise location as an established ground truth that is incorporated into existing calibration functions. Additionally, in at least some embodiments, the established ground truth may be incorporated into one or more localization functions executed by the autonomy system.

The system described herein provides certain technical advantages over known sensor calibration systems. For example, the system described herein enables calibration to be performed while the vehicle is online (e.g., during normal driving). Additionally, the system does not require additional sensors or dedicated infrastructure, because autonomous vehicles frequently have microphones or accelerometers (or other suitable haptic sensors) thereon. Even where additional sensors are added to the autonomous vehicle to support the haptic feedback processing described herein, these sensors do not significantly add to the complexity or cost of the system. Moreover, the haptic feedback enables a source of ground-truth data for sensor calibration that is otherwise performed as a relative process, in which errors may propagate and are difficult to isolate.

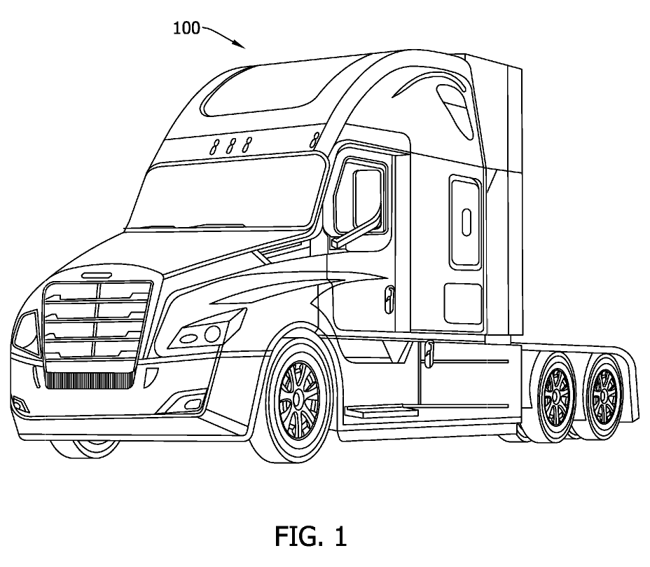

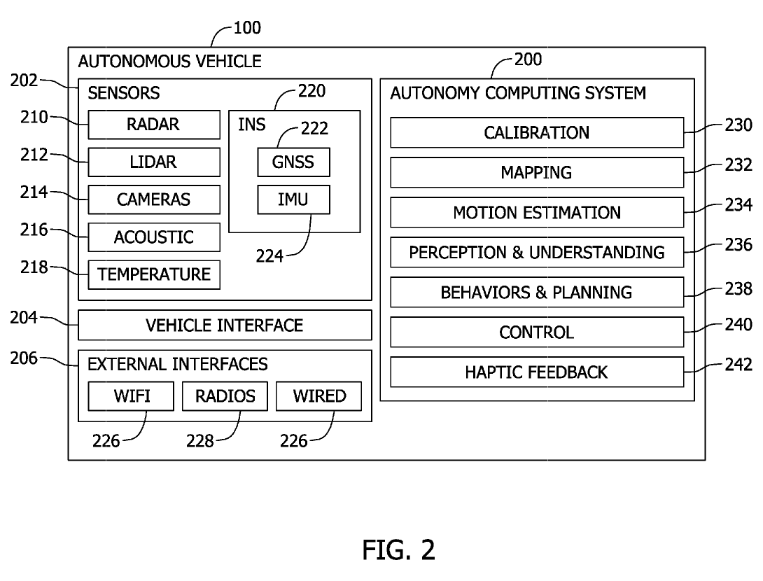

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216 (e.g., microphones), temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, other acoustic (e.g., ultrasound) sensors, internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operation of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras’ FOVs, which may be used to, for example, generate a bird’s eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration in at least one direction (or relative to at least one dimension of autonomous vehicle 100) using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 229, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a haptic feedback module 242. Haptic feedback module 242, for example, may be embodied within another module, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous. The term “online” refers to control of autonomous vehicle 100 by autonomy computing system 200, including while autonomous vehicle 100 is in motion.

Autonomy computing system 200 is configured to detect a haptic response of autonomous vehicle 100 when autonomous vehicle 100 encounters a known road feature while online. Autonomy computing system 200 detects this haptic response from one or more haptic sensors, which may include acoustic sensors 216 (e.g., a microphone), IMUs 224 (e.g., an accelerometer), and/or one or more dedicated haptic sensors (not shown). The haptic response is characterized by a feedback signature that includes a magnitude of the haptic response as well as a timestamp of the time at which the haptic response was captured. The timestamp may be as precise as single seconds, or even milliseconds. At a same time, a location measurement of the precise position of autonomous vehicle 100 is captured, for example, using INS 220 or other sensors 202.

In the example embodiment, autonomy computing system 200 receives haptic feedback data from the haptic sensors and location data from, for example, INS 220. In some embodiments, autonomy computing system 200 may cache these data in a memory location accessible to haptic feedback module 242. Autonomy computing system 200 uses the location of autonomous vehicle 100 at the time the haptic feedback data was captured, as well as the feedback signature, to identify a known, mapped road feature encountered by autonomous vehicle 100 (e.g., using haptic feedback module 242 and, in some embodiments, additional modules).

Autonomy computing system 200 may then confirm or validate the location of autonomous vehicle 100 at the time the haptic feedback data was captured. The location of autonomous vehicle 100 includes a ground-truth location of the road feature relative to one or more HD maps in one or more dimensions of autonomous vehicle 100, such as a lateral dimension or a longitudinal or direction-of-travel dimension. Autonomy computing system 200 may store this ground-truth location for access by one or more modules thereof. In particular, in some embodiments, calibration module 230 accesses the ground-truth location for use as an input during a sensor calibration process. Additionally or alternatively, mapping module 232 (or another module of autonomy computing system 200) accesses the ground-truth location as an input to a vehicle localization process.

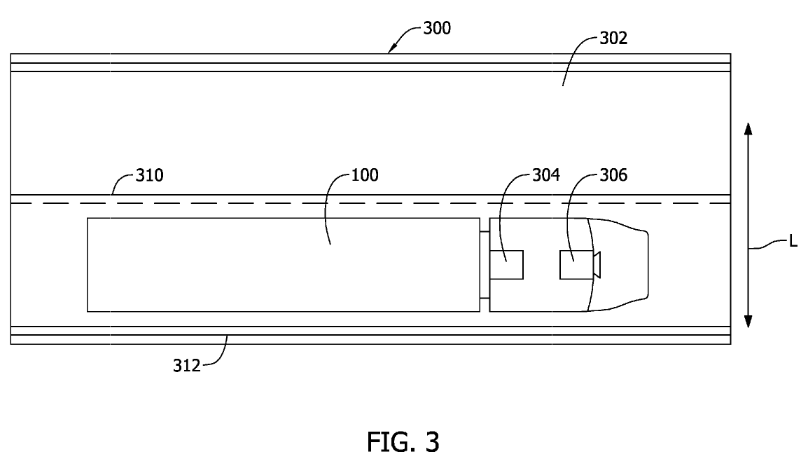

FIG. 3 depicts a first embodiment of capturing haptic feedback data for online sensor calibration and vehicle localization. In this embodiment, autonomous vehicle 100 is travelling in an environment 300 including a road 302. Autonomous vehicle 100 includes haptic sensor(s) 304, as well as visualization sensors 306. In this embodiment, visualization sensors 306 include a camera, RADAR, LiDAR, or other sensor that captures sensor data for autonomy computing system 200 (shown in FIG. 2) to control autonomous vehicle 100 along road 302.

Road 302 includes a central lane marker 310 as well as a road feature including an outer road marker 312. Outer road marker 312 includes a visual indicator, embodied as a white lane line, as well as a haptic indicator, embodied as rumble strips. In some cases, central lane marker 310 may also include a haptic indicator, such as rumble strips.

In some instances, autonomous vehicle 100 travels slowly in a lateral direction L, towards outer road marker 312. At some moment, autonomous vehicle 100 travels over outer road marker 312, and haptic sensor(s) 304 detect a haptic response from autonomous vehicle 100. The feedback signature, including the magnitude and timestamp, of the haptic response is recorded (e.g., at a memory local to autonomous vehicle 100). At the same moment, a sensed location of autonomous vehicle 100 is captured, such as from INS 220 or other location sensors 202 (both shown in FIG. 2), and recorded. That is, the sensed location (sensor data) has a same timestamp as the feedback signature.

Autonomy computing system 200 (e.g., using haptic feedback module 242) uses the feedback signature as well as the sensed location of autonomous vehicle 100 to identify the road feature that autonomous vehicle 100 just encountered – in this example, outer road marker 312 – from HD maps accessible to autonomy computing system 200. The road feature has a precise location in the HD map, that is, the ground-truth location of the road feature and, thereby, of autonomous vehicle 100 at the time autonomous vehicle 100 encountered the road feature. Autonomy computing system 200 compares the sensed location of autonomous vehicle 100 to the known, precise location of the road feature. This comparison may facilitate lateral sensor calibration of sensors of autonomous vehicle 100. Specifically, the comparison may identify a discrepancy in calibration of one or more sensors, and autonomy computing system 200 may initiate one or more sensor calibration functions using the ground-truth location of autonomous vehicle 100 as an input.

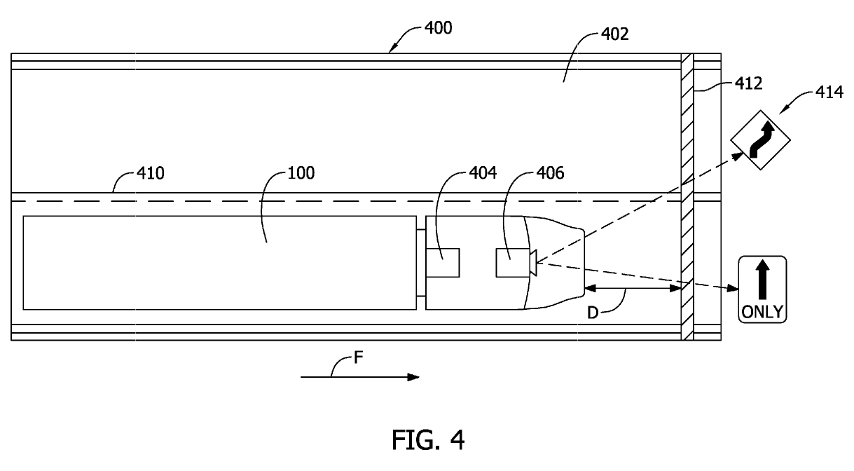

FIG. 4 depicts a second embodiment of capturing haptic feedback data for online sensor calibration. In this embodiment, autonomous vehicle 100 is travelling in an environment 400 including a road 402. Autonomous vehicle 100 includes haptic sensor(s) 404, as well as visualization sensors 406. In this embodiment, visualization sensors 406 include a camera, RADAR, LiDAR, or other sensor that captures sensor data for autonomy computing system 200 (shown in FIG. 2) to control autonomous vehicle 100 along road 402.

Road 402 includes lane markers 410 and a road feature 412. Road feature 412 may include, for example, an expansion joint. In the example embodiment, the precise location of road feature 412 is known and mapped within the HD maps used by autonomy computing system 200. Environment 400 further includes environmental features 414 external to road 402, embodied here as road signs. In the example embodiment, the precise location of each environmental feature 414 is known and mapped within the HD maps.

Autonomous vehicle 100 travels straight in a forward direction F, towards road feature 412. Visualization sensors 406 capture sensor data related to environmental features 414 within their FOV, and autonomy computing system 200 maps autonomous vehicle 100 to a particular location in HD maps based on the sensed environmental features 414. Autonomy computing system 200 uses this sensed location to determine that road feature 412 is a distance D from road feature 412 – or, more precisely, that autonomous vehicle 100 should be distance D from road feature 412, if visualization sensors 406 and location sensors (e.g., INS 220 or other location sensors 202) are precisely and accurately calibrated. Autonomy computing system 200 also calculates an expected time of arrival (ETA) for autonomous vehicle 100 to reach road feature 412, based on distance D and a current speed and heading of autonomous vehicle 100.

At some moment, autonomous vehicle 100 travels over road feature 412, and haptic sensor(s) 404 detect a haptic response from autonomous vehicle 100. The feedback signature, including the magnitude and timestamp, of the haptic response may be recorded (e.g., at a memory local to autonomous vehicle 100). At the same moment, a sensed location of autonomous vehicle 100 is captured, such as from INS 220 or other location sensors 202, and recorded. That is, the sensed location (sensor data) has a same timestamp as the feedback signature. Road feature 412 has a precise location in the HD map, that is, the ground-truth location of road feature 412 and, thereby, of autonomous vehicle 100 at the time autonomous vehicle 100 encountered road feature 412.

Autonomy computing system 200 (e.g., using haptic feedback module 242) compares the timestamp of the feedback signature to the calculated ETA. If any discrepancy is detected, autonomy computing system 200 may initiate at least one sensor calibration process to improve the depth calibration and/or speed calibration of sensors 202, using the ground-truth location of road feature 412 and relative timestamps of the haptic feedback and ETA.

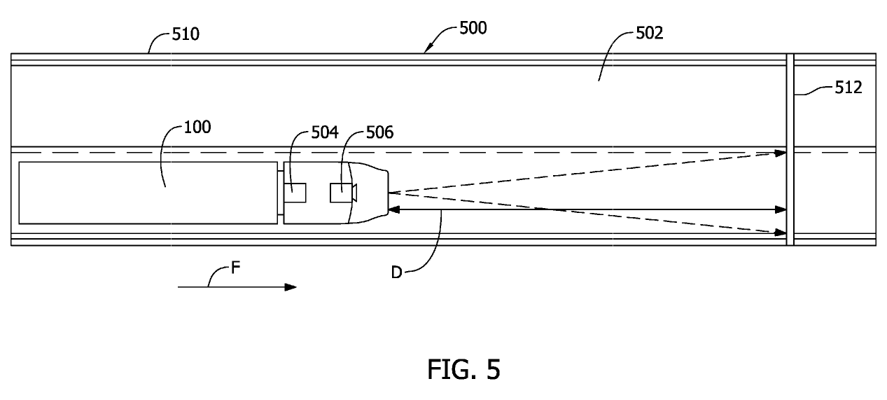

FIG. 5 depicts a third embodiment of capturing haptic feedback data for online sensor calibration. In this embodiment, autonomous vehicle 100 is travelling in an environment 500 including a road 502. Autonomous vehicle 100 includes haptic sensor(s) 504, as well as visualization sensors 506. In this embodiment, visualization sensors 506 include a camera, RADAR, LiDAR, or other sensor that captures sensor data for autonomy computing system 200 (shown in FIG. 2) to control autonomous vehicle 100 along road 502.

Road 502 includes lane markers 510 and a road feature 512. Road feature 512 may include, for example, an expansion joint. In the example embodiment, the precise location of road feature 512 is known and mapped within the HD maps used by autonomy computing system 200.

Autonomous vehicle 100 travels straight in forward direction F, towards road feature 512. Visualization sensors 506 capture sensor data related to road feature 512 within their FOV, and autonomy computing system 200 uses this sensor data to determine autonomous vehicle 100 is a distance D from road feature 512 – or, more precisely, that autonomous vehicle 100 should be distance D from road feature 512, if visualization sensors 406 and location sensors (e.g., INS 220 or other location sensors 202) are precisely and accurately calibrated. Autonomy computing system 200 calculates an ETA for autonomous vehicle 100 to reach road feature 512, based on distance D and a current speed and heading of autonomous vehicle 100.

At some moment, autonomous vehicle 100 travels over road feature 512, and haptic sensor(s) 504 detect a haptic response from autonomous vehicle 100. The feedback signature, including the magnitude and timestamp, of the haptic response may be recorded (e.g., at a memory local to autonomous vehicle 100). At the same moment, a sensed location of autonomous vehicle 100 is captured, such as from INS 220 or other location sensors 202, and recorded. That is, the sensed location (sensor data) has a same timestamp as the feedback signature. Road feature 512 has a precise location in the HD map, that is, the ground-truth location of road feature 512 and, thereby, of autonomous vehicle 100 at the time autonomous vehicle 100 encountered road feature 512.

Autonomy computing system 200 (e.g., using haptic feedback module 242) compares the timestamp of the feedback signature to the calculated ETA. If any discrepancy is detected, autonomy computing system 200 may initiate at least one sensor calibration process to improve the depth calibration and/or speed calibration of sensors 202, using the ground-truth location of road feature 512 and relative timestamps of the haptic feedback and ETA.

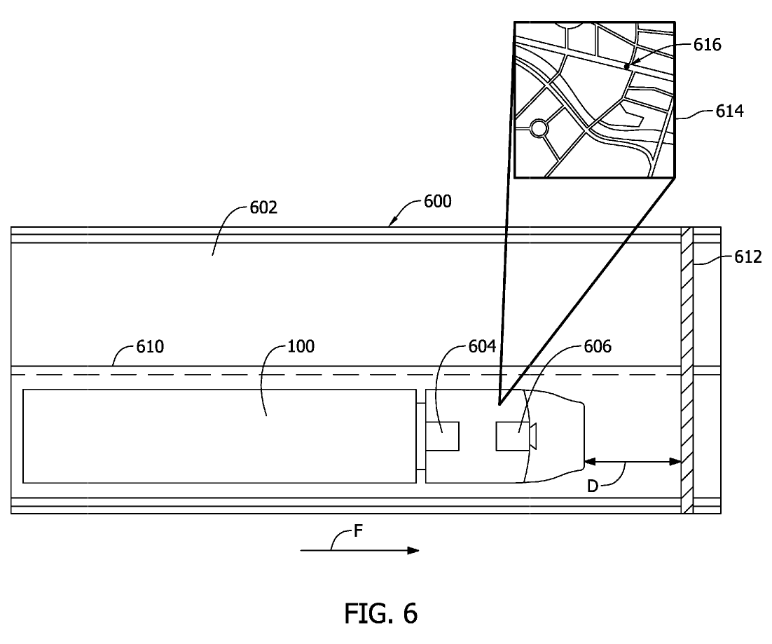

FIG. 6 depicts a fourth embodiment of capturing haptic feedback data for online sensor calibration. In this embodiment, autonomous vehicle 100 is travelling in an environment 600 including a road 602. Autonomous vehicle 100 includes haptic sensor(s) 604, as well as location sensors 606. In this embodiment, location sensors 606 include IMU’s (e.g., IMU’s 224, shown in FIG. 2), and capture sensor data associated with the location, speed, and heading of autonomous vehicle 100.

Road 602 includes lane markers 610 and a road feature 612. Road feature 612 may include, for example, an expansion joint. In the example embodiment, the precise location of road feature 612 is known and mapped within the HD maps used by autonomy computing system 200 for localization of autonomous vehicle 100. A representation of an HD map is shown in FIG. 6, designated as map 614. The location of road feature 612 is represented as location 616 on map 614.

Autonomous vehicle 100 travels straight in forward direction F, towards road feature 612. Location sensors 606 capture sensor data related to the location, speed, and heading to autonomous vehicle 100. Autonomy computing system 200 uses this captured sensor data to map autonomous vehicle 100 to a particular location (not shown) of map 614. Autonomy computing system 200 uses this mapped location to determine that autonomous vehicle 100 is approaching road feature 612 and that autonomous vehicle 100 is a distance D from road feature 612 – or, more precisely, that autonomous vehicle 100 should be distance D from road feature 612, if location sensors (e.g., INS 220 or other location sensors 202) are precisely and accurately calibrated. Autonomy computing system 200 calculates an ETA for autonomous vehicle 100 to reach road feature 612, based on distance D and the sensed location, speed, and heading of autonomous vehicle 100.

At some moment, autonomous vehicle 100 travels over road feature 612, and haptic sensor(s) 604 detect a haptic response from autonomous vehicle 100. At the same moment, a sensed location of autonomous vehicle 100 is captured. The feedback signature, including the magnitude and timestamp, of the haptic response may be recorded (e.g., at a memory local to autonomous vehicle 100). At the same moment, a sensed location of autonomous vehicle 100 is captured, such as from INS 220 or other location sensors 202, and recorded. That is, the sensed location (sensor data) has a same timestamp as the feedback signature. The precise location 616 of road feature 612 in map 614 is stored as the ground-truth location of autonomous vehicle 100 at the time of the feedback signature.

Autonomy computing system 200 (e.g., using haptic feedback module 242) compares the timestamp of the feedback signature to the calculated ETA. If any discrepancy is detected, autonomy computing system 200 may initiate at least one sensor calibration process to improve the depth calibration and/or speed calibration of sensors 202, or the location sensors or corresponding localization functions, using the ground-truth location of road feature 612 and relative timestamps of the haptic feedback and ETA.

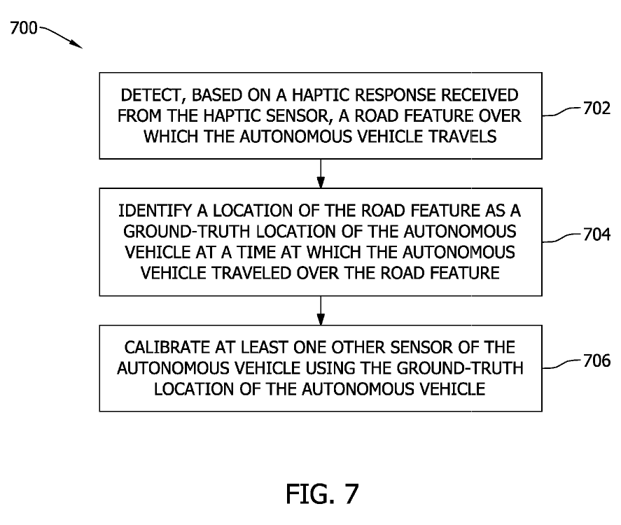

FIG. 7 is a flowchart of an example method 700 for sensor calibration. In the example embodiment, method 700 is performed by autonomy computing system 200 (shown in FIG. 2) executing haptic feedback module 242.

Method 700 includes detecting 702, based on a haptic response received from the haptic sensor, a road feature over which the autonomous vehicle travels. Method 700 also includes identifying 704 a location of the road feature as a ground-truth location of the autonomous vehicle at a time at which the autonomous vehicle traveled over the road feature. Method 700 further includes calibrating 706 at least one other sensor of the autonomous vehicle using the ground-truth location of the autonomous vehicle.

Method 700 may include additional, fewer, or alternative steps, including those described elsewhere herein.

In some embodiments, the ground-truth location of the autonomous vehicle is relative to a lateral dimension of the autonomous vehicle, and method 700 further includes determining the road feature is an outer road marking. In some further embodiments, the autonomous vehicle also includes one or more visualization sensors, and method 700 includes confirming, using the one or more visualization sensors, the autonomous vehicle is crossing the outer road marking in the lateral dimension.

In some embodiments, method 700 further includes identifying, prior to detecting 702, the road feature a distance ahead of the autonomous vehicle. Method 700 may additionally include identifying, using one or more visualization sensors, the road feature based on a sensed environmental external to a road on which the autonomous vehicle is traveling. Method 700 may additionally or alternatively include identifying, using one or more visualization sensors, the road feature present on a road on which the autonomous vehicle is traveling. Method 700 may include identifying the road feature using a high-definition map stored on the autonomous vehicle. In some further embodiments, method 700 includes matching a feedback signature of the haptic response and a sensed location of the autonomous vehicle to a stored feedback signal associated with the road feature and the ground-truth location of the road feature on the high-definition map.

In some embodiments, method 700 also includes initiating a localization function using the ground-truth location of the autonomous vehicle.

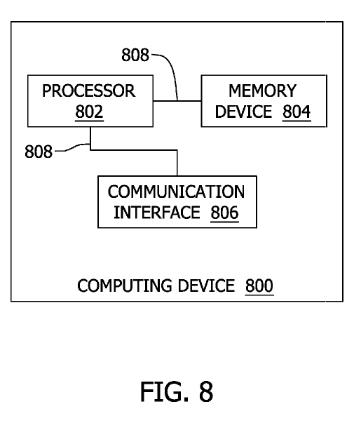

FIG. 8 is a block diagram of an example computing device 800. Computing device 800 includes a processor 802 and a memory device 804. The processor 802 is coupled to the memory device 804 via a system bus 808. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 804 includes one or more devices that enable information, such as executable instructions or other data (e.g., sensor data), to be stored and retrieved. Moreover, the memory device 804 includes one or more computer readable media, such as, without limitation, dynamic random-access memory (DRAM), static random-access memory (SRAM), a solid-state disk, or a hard disk. In the example embodiment, the memory device 804 stores, without limitation, application source code, application object code, configuration data, additional input events, application states, assertion statements, validation results, HD maps, mapped road feature data, location data, or any other type of data. The computing device 800, in the example embodiment, may also include a communication interface 806 that is coupled to the processor 802 via system bus 808. Moreover, the communication interface 806 is communicatively coupled to data acquisition devices.

In the example embodiment, processor 802 may be programmed by encoding an operation using one or more executable instructions and providing the executable instructions in the memory device 804. In the example embodiment, the processor 802 is programmed to perform the steps of method 700 shown in FIG. 7, as well as other functions, including those described elsewhere herein.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) enhanced online sensor calibration using a data point that is not relative to any other sensors; (b) identification of a ground-truth location with existing sensors of an autonomous vehicle; and (c) facilitating improved localization while the autonomous vehicle is traveling, using the established ground-truth location.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for sensor calibration, the system comprising a processor in communication with a memory device and at least one haptic sensor of an autonomous vehicle, the processor programmed to:
detect, based on a haptic response received from the haptic sensor, a road feature over which the autonomous vehicle travels;
identify a location of the road feature as a ground-truth location of the autonomous vehicle at a time at which the autonomous vehicle traveled over the road feature; and
calibrate at least one other sensor of the autonomous vehicle using the ground-truth location of the autonomous vehicle.

2. The system of claim 1, wherein the at least one haptic sensor comprises a microphone or accelerometer.

3. The system of claim 1, wherein the ground-truth location of the autonomous vehicle is relative to a lateral dimension of the autonomous vehicle, wherein the processor is further programmed to:
determine the road feature is an outer road marking.

4. The system of claim 3, further comprising one or more visualization sensors, wherein the processor is further programmed to:
confirm, using the one or more visualization sensors, the autonomous vehicle is crossing the outer road marking in the lateral dimension.

5. The system of claim 1, wherein the processor is further programmed to:
identify, prior to the detecting, the road feature a distance ahead of the autonomous vehicle.

6. The system of claim 5, further comprising one or more visualization sensors, wherein the processor is further programmed to:
identify, using the one or more visualization sensors, the road feature based on a sensed environment external to a road on which the autonomous vehicle is traveling.

7. The system of claim 5, further comprising one or more visualization sensors, wherein the processor is further programmed to:
identify, using the one or more visualization sensors, the road feature present on a road on which the autonomous vehicle is traveling.

8. The system of claim 5, wherein the processor is further programmed to:
identify the road feature using a high-definition map stored on the autonomous vehicle.

9. The system of claim 8, wherein the processor is further programmed to:
match a feedback signature of the haptic response and a sensed location of the autonomous vehicle to a stored feedback signal associated with the road feature and the ground-truth location of the road feature on the high-definition map.

10. The system of claim 1, wherein the processor is further programmed to:
initiate a localization function using the ground-truth location of the autonomous vehicle.

11. A method for online sensor calibration of an autonomous vehicle, the autonomous vehicle including at least one haptic sensor, the method comprising:
detecting, based on a haptic response received from the haptic sensor, a road feature over which the autonomous vehicle travels;
identifying a location of the road feature as a ground-truth location of the autonomous vehicle at a time at which the autonomous vehicle traveled over the road feature; and
calibrating at least one other sensor of the autonomous vehicle using the ground-truth location of the autonomous vehicle.

12. The method of claim 11, wherein the ground-truth location of the autonomous vehicle is relative to a lateral dimension of the autonomous vehicle and the autonomous vehicle further includes one or more visualization sensors, the method further comprising:
determining the road feature is an outer road marking; and
confirming, using the one or more visualization sensors, the autonomous vehicle is crossing the outer road marking in the lateral dimension.

13. The method of claim 11, further comprising:
identifying, prior to the detecting, the road feature a distance ahead of the autonomous vehicle.

14. The method of claim 13, wherein the autonomous vehicle further includes one or more visualization sensors, the identifying comprising one of:
identifying, using the one or more visualization sensors, the road feature based on a sensed environment external to a road on which the autonomous vehicle is traveling; or
identifying, using the one or more visualization sensors, the road feature present on a road on which the autonomous vehicle is traveling.

15. The method of claim 13, wherein the identifying comprises:
identifying the road feature using a high-definition map stored on the autonomous vehicle.

16. The method of claim 15, further comprising:
matching a feedback signature of the haptic response and a sensed location of the autonomous vehicle to a stored feedback signal associated with the road feature and the ground-truth location of the road feature on the high-definition map.

17. The method of claim 11, further comprising:
initiating a localization function using the ground-truth location of the autonomous vehicle.

18. An autonomous vehicle comprising an autonomy computing system including at least one haptic sensor, the autonomy computing system configured to:
detect, based on a haptic response received from the haptic sensor, a road feature over which the autonomous vehicle travels;
identify a location of the road feature as a ground-truth location of the autonomous vehicle at a time at which the autonomous vehicle traveled over the road feature; and
calibrate at least one other sensor of the autonomous vehicle using the ground-truth location of the autonomous vehicle.

19. The autonomous vehicle of claim 18, wherein the at least one haptic sensor comprises a microphone or accelerometer.

20. The autonomous vehicle of claim 18, wherein the autonomy computing system is further configured to:
initiate a localization function using the ground-truth location of the autonomous vehicle.
